(19) United States
(12) Patent Application Publication
(10) Pub. No.: US 2006/0147604 A1
(43) Pub. Date: Jul. 6, 2006

(54) Water continuous product stabilised with acetic acid

(76) Inventors: Josephus Henricus De Laat, Vlaardingen (NL); Barbara Margeretha Pelan, Rottendam (NL); Christel Karine Reiggers-Magnani, Vlaardingen (NL); Aleksander Arie Reszka, Vlaardingen (NL); Patrick Cornelis Wouters, Vlaardingen (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/539,149

(22) PCT Filed: Nov. 11, 2003
(86) PCT No.: PCT/EP03/12603

§ 371 Date: Jan. 13, 2006

(30) Foreign Application Priority Data
Dec. 19, 2002 (EP) 02080472.0

(51) Int. Cl. A23D 9/00

(52) U.S. Cl. 426/603

(57) ABSTRACT

Chemically acidified water continuous products which have been acidified with a combination of a food grade acid and a small amount of acetic acid were found to be very stable against microbial spoilage.

### FIELD OF THE INVENTION

The invention relates to water continuous products that are stable against microbiological spoilage, especially at a temperature below 20° C., preferably below 15° C.

### BACKGROUND OF THE INVENTION

Water continuous products such as oil in water emulsions are prone to microbial spoilage on storage. Among these products are dressings, mayonnaise, fresh cheese, creamy spreads such as those disclosed in WO-A-97/08956 and quark type of products.

For each of these products measures are taken to ensure that they have a suitable shelf life when closed and also to ensure that they are not spoiled immediately after storage but can safely be consumed for some time after opening. One of the bacteria causing spoilage after the product has been opened are those belonging to the family of Enterobacteriaceae. These bacteria are also relevant in relation to product safety. Another group of bacteria which are preferably absent in products are Listeria.

For microbial preservation many of the above products rely on a preservation system which is a combination of heating (e.g. pasteurisation, sterilisation) and acid level (pH) to kill any vegetative cells present in the product and to inhibit bacterial spores. Heating is in many cases sufficient to ensure closed shelf life prevented products are hermetically sealed after packing. Acid level is e.g. used in dressings where generally the level of acetic acid is about 0.1 to 2 wt % on product weight.

U.S. Pat. No. 6,387,427 for example discloses a method of preserving a food product by adding a fermentate comprising acetic acid and/or its salts resulting from the fermentation by acetic acid producing bacteria while the pH is maintained below 5.8. Although such products may be stable, the production of the fermentate by microbial acidification is time consuming and also the composition of the fermentate may vary depending on the exact conditions of microbial acidification, which are difficult to control very accurately. Furthermore the acetic acid levels are such that for many products an undesired acetic taste and flavour may be present.

Furthermore e.g. products disclosed in WO-A-97/08956 which have been prepared by microbial acidification may be stable but they again require a step wherein microbial acidification is applied which is in some cases undesired. Microbial acidification may take long and makes exact process control of e.g. the pH difficult.

Although it is known from the art that microbial acidification may be replaced by chemical acidification, we found that this does not always lead to products with the desired microbial stability. For instance products wherein an acidic pH is obtained by the mere addition of citric acid were found to spoil relatively easily, especially once opened unless they contain very high amounts of citric acid.

Therefore it is an object of the invention to provide chemically acidified products that are microbiologically stable on storage.

Especially preferred the products are essentially free of Enterobacteriaceae and Listeria.

### SUMMARY OF THE INVENTION

We suprisingly found that a combination of a food grade acid with a very small amount of acetic acid gives highly improved microbiological stability for water continuous products.

Therefore the invention relates to a water continuous, chemically acidified product comprising a fat, from 0.1 to 15 wt % protein, acids, and having a pH from 3.5 to 5.5 wherein the acids comprise a combination of at least one food grade acid in an amount of from 0.01 to 2 wt % and from 10 to 1000 ppm acetic acid, on the weight of the product.

### DETAILED DESCRIPTION OF THE INVENTION

In the context of the invention, the terms “fat” and “oil” are used interchangeably. The term oil encompasses both triglyceride oils and diglyceride oils. Where the term fat is used also fat replacers such as sucrose polyesters are encompassed.

For the purpose of the current invention, wt % is defined as weight percent on total product weight unless otherwise is indicated.

Where the weight amount of an acid is referred to, the amount is calculated in terms of the total amount of dissociated and undissociated acid, unless otherwise is indicated.

The products according to the invention are chemically acidified. This means that the desired acidic pH is obtained by the addition of (food grade) acids, contrary to the other method of acidification which is microbial acidification. Therefore preferred products are essentially free from bacteria which are suitable for microbial acidification (which is also referred to as fermentation). Examples of such bacteria are lactic acid bacteria, cheese starter cultures, yoghurt cultures, acetic acid producing bacteria. The presence of such bacteria (alive or dead after a heat treatment) may be demonstrated by any suitable technique such as ribosomal RNA identification with fluorescent oligonucleotides or PCR of DNA.

The products according to the invention comprise a continuous aqueous phase. The dispersed phase is preferably fat or oil or a replacer thereof. Preferred products are spreadable, liquid and spoonable emulsions such as fresh cheese, spreads, low fat spreads, sauces, creams, drinks, acidified drinks, acidified milk, mousses, desserts, dairy spreads.

The products comprise a protein in an amount from 0.1 to 15 wt %. Especially products with protein present in the aqueous phase were found to be prone to microbial spoilage and hence will benefit from the invention because proteins are a well known source of energy for bacteria to grow on.

The products are acidified to a pH of from 3.5 to 5.5. The water continuous products preferably have a pH from 3.8 to 5.2, more preferably from 4 to 5.2, more preferred from 4.2 to 5.2, even more preferred 4.2 to 4.9.

The desired pH is obtained by the addition of a combination of at least one food grade acid in an amount from 0.01 to 2 wt % and from 10 to 1000 ppm acetic acid.

The preferred amount of food grade acid is from 0.1 to 1.2 wt %, more preferred from 0.2 to 0.7 wt %. The skilled person will appreciate that the amount of acid added is linked to the desired pH of the final product and the strength of the particular acid.

It is well known that microbiologically produced acids during fermentation impart a specific, pleasant taste to food products. Therefore in a preferred embodiment, the food grade acid is composed of acids that are formed during fermentation.

The food grade acid is preferably selected from the group comprising citric acid, lactic acid, hydrocholoric acid, benzoic acid, propionic acid, fumaric acid or a combination thereof. Also derived forms of these such as their salts are encompassed within the invention. Maleic acid is less preferred.

The most preferred food grade acid is citric acid or a combination of citric acid and lactic acid. In preferred products the total amount of lactic acid is preferably below 0.5 wt %, for taste reasons.

The amount of citric acid is preferably from 0.1 to 0.8 wt %, more preferred from 0.2 to 0.4 wt % on total product weight.

It was surprisingly found that the addition of only a small amount of acetic acid showed a very good improvement in inhibition of microbial growth, especially of bacteria of the species Enterobacteriaceae. In a preferred embodiment the amount of acetic acid on total product weight is from 50 to 500 ppm, more preferred from 50 to 300 ppm, even more preferred from 100 to 300 ppm, most preferred from 150 to 250 ppm.

In an even more preferred embodiment, the amount of undissociated acetic acid is controlled such that it is at least 75 ppm, more preferred at least 80 ppm, even more preferred at least 100 ppm, even more preferred at least 150 ppm.

The higher levels of over 100 ppm undissociated acid are especially suitable to target stability against Listeria. The levels of undissociated acetic acid from 75 ppm up to about 250 ppm are preferred to specifically target Enterobacteriaceae.

The invention is for example applicable to products which are of a creamy spread type. In such products the level of acetic acid is preferably below 500 ppm to avoid a strong acetic taste for these products. For other products such as dressings the amount of acetic acid may be a bit higher because such products are usually characterised by an acetic acid taste and flavour.

In an even more preferred embodiment, the product comprises citric acid in an amount of from 0.2 to 0.4 wt % and acetic acid in amount from 100 to 300 ppm on total product weight, preferably 80-200 ppm undissociated acetic acid on total product weight.

The products preferably are water continuous products comprising from 1 to 40 wt % vegetable fat, 0.5 to 10 wt % milk protein and 0.01 to 3 wt % thickener, having a pH from 4.2 to 5.5. These products are nutritionally balanced and hence preferably comprise essential nutrients while they are low fat.

The products according to the invention comprise a fat or a fat replacer. Most preferred products are emulsions of a continuous aqueous phase and a dispersed fat phase.

The fat or fat replacer is preferably present in an amount of from 5 to 90 wt %, more preferred from 5 to 70 wt %, more preferred from 5 to 50 wt %, even more preferred from 10 to 40 wt %, most preferred from 15 to 35 wt %. The invention is especially beneficial for products with a high amount of aqueous phase such as those where the amount of fat is below 60 wt %. Such products are therefore preferred.

Although any suitable fats such as dairy fat, vegetable fat and fish oil may be used, the preferred fat is vegetable fat. The vegetable fat is preferably a fat rich in polyunsaturated fatty acids. Most preferred the fat is selected from the group comprising palmkernel oil, olive oil, soybean oil, rapeseed oil, coconut oil, sunflower oil, safflower oil, or fully or partially hardened fractions thereof. In a further preferred embodiment, the total amount of saturated fatty acid components in the fat is less than 45 wt %, based on the total amount of fatty acid components, and further preferred less than about 30 wt %.

The products comprise a protein. The protein may be any protein such as milk protein, soy protein, pea protein, meat protein. Preferred products comprise from 0.5 to 10 wt % protein, preferably from 1.5 to 10 wt %, more preferred from 2 to 5 wt % protein.

Preferably the protein is milk protein and even more preferred the milk protein is derived from the group comprising cream, milk, skim milk, butter milk, whey, casein or their powders or a combination of any of these. The most preferred milk protein source is skim milk powder.

The preferred amount of milk protein is from 2 to 6 wt %, more preferred from 2.5 to 4.5 wt %.

Although the invention is applicable for water continuous products of any kind of texture, it is especially preferred that products are spreadable.

Therefore in a preferred embodiment the invention relates to products that are plastic, spreadable products, which can be applied onto bread at room temperature without tearing the bread. The products of the present invention preferably have a Stevens value of 100-500 g at 10° C. and 25-250 g at room temperature (about 20° C.), more preferred 150-450 g at 10° C. and 25-200 g at room temperature (about 20° C.). The method to determine Stevens value hardness is described in the examples.

To obtain the desired consistency and spreadable characteristics, the products according to the invention optionally comprise a thickener. The thickener is preferably a biopolymer selected from the group comprising locust bean gum guar gum, tara gum, amylopectin, methylcellulose, alginate, starch, modified starch, high molecular weight pectin, gelatin or combinations thereof.

The preferred amount of thickener is from 0.1 to 3 wt %, more preferred from 0.3 to 2 wt %.

Optionally the product further comprises an ingredient selected from the group comprising vitamins, anti-oxidants, flavouring agent, egg yolk, gelatin, salt, metal ions such as calcium, potassium or a combination thereof.

Although the acid combination according to the invention has a good contribution to improving the microbial stability of water continuous products against spoilage by especially Enterobacteriaceae, further ingredients are optionally introduced to specifically provide protection against other bacteria. An example of a suitable other anti-microbial agent that is optionally included in the product is potassium sorbate.

The products according to the invention are microbiologically stable. The microbial stability may be determined by the test described in the examples.

The product may be prepared in any suitable way. A suitable process is for example disclosed in WO-A-97/08956. It is preferred that the product is filled into a container at a temperature from 60 to 80° C. whereafter the container is stored at a temperature below 10° C. More preferred the filling temperature is from 65 to 75° C.

The invention is illustrated in the following non-limiting examples.

### EXAMPLES

Stevens Hardness

The firmness of the products is determined by measuring the force required to penetrate a cylindrical probe in the product. Sample height 5 cm; cylindrical probe of 0.5 inch thickness; compression rate 2 mm/s; penetration depth 20 mm. The samples are stored for 7 days at 5° C., and stored at 10 or 20° C. for 4 h before the firmness measurement.

Microbial Stability Test

The microbiological stability of the products is determined using a “challenge” test which is a common test in the determination of microbiological stability.

The test was carried out as follows.

Products were opened and a cocktail of strains of the Enterobacteriaceae family was added. Products were incubated at 10, 15 and 25° C. for several days. The amount of growth of Enterobacteriaceae was determined by plating decimal dilution series of the “infected” products on agar plates. The plates were incubated at 30° C. for 2 to 5 days after which the numbers of grown colonies were counted. Typically for Enterobacteriaceae the increase of the number of colonies was determined versus time.

### Example 1

TABLE 1
Compositions

| | Wt % on |
|---|---|
| Ingredient | product |
| Fat (sunflower oil) | 22 |
| Skim Milk Powder | 6.25 |
| Whey protein concentrate | 1.75 |
| (Nutrilac) | |
| Locust Bean Gum (LBG) | 0.3 |
| Gelatin | 0.7 |
| Salt | 0.3 |
| Citric acid | 0.35 |
| (added as a powder) | |
| Acetic acid | 200 ppm |
| (added as 100% liquid) | |
| Carotene stock | 4 ppm |
| solution, 1% in oil | |
| Demineralised water | Up to 100% |

Comparative example C1: same ingredients except that there was no acetic acid.

Process:

Water phase and fat phase ingredients except for acids were mixed at about 60° C. After mixing the composition was pasteurized at 85° C. for 10 minutes, and cooled down to 44° C., after which homogenisation at 200 bar took place. To the homogenized composition acid was added as indicated, where needed hydrochloric acid was added until a pH of about 4.7 or 4.5 was reached. This was followed by heating the mixture to 85° C. The obtained product was homogenized at 300 bar, and subsequently heated to a temperature of 75° C. for filling containers. The product was filled into the containers. The container was stored below 10° C.

The product was presented to a panel of consumers. The products were easily spreadable. All confirmed that both products had a pleasant mouthfeel and taste and did not have an acetic acid off taste.

The results of the microbial stability tests were:

The samples with acetic acid (according to the invention) did not show any increase of colonies of Enterobacteriaceae over time. After about 10 days at 10° C., even a reduction in the initial number of colonies was observed at pH 4.7.

For products at pH 4.7 without acetic acid (comparative example) growth of Enterobacteriaceae started between about 3 to 7 days storage at 10° C. After about 10 days the amount of colonies had increased about 10-fold.

For products at pH 4.5 without acetic acid, the growth of colonies was deferred but was observed to start after storage for 10 to 14 days at 10° C.

This confirms that the addition of a small amount of acetic acid inhibits microbial growth of Enterobacteriaceae. Therefore such products have a longer open shelf life.

1. Water continuous, chemically acidified product comprising a fat, from 0.1 to 15 wt % protein, acids, and having a pH from 3.5 to 5.5 characterised in that the acids comprise a combination of at least one food grade acid in an amount of from 0.01 to 2 wt % and from 10 to 500 ppm acetic acid, on the weight of the product.

2. Water continuous product according to claim 1 wherein the food grade acid is selected from the group comprising citric acid, lactic acid, hydrochloric acid, benzoic acid, propionic acid or a combination thereof.

3. Water continuous product according to claim 2 wherein the food grade acid is citric acid or a combination of citric acid and lactic acid.

4. Water continuous product according to claim 1 with a pH from 3.8 to 5.2, more preferred from 4.2 to 4.9.

5. Water continuous product according to claim 1, which comprises from 5 to 90 wt % oil.

6. Water continuous product according to claim 1 which comprises citric acid in an amount of from 0.2 to 0.4 wt % and acetic acid in amount from 100 to 300 ppm on total product weight.

7. Water continuous product according to claim 1 wherein the amount of fat is from 1 to 40 wt % fat, said product further comprising 0.5 to 10 wt % milk protein and 0.01 to 3 wt % thickener and having a pH from 4.2 to 5.5.

8. Water continuous product according to claim 1, wherein the amount of lactic acid is below 0.5 wt % on total product weight.
